(19) United States
(12) Patent Application Publication
(10) Pub. No.: US 2011/0257888 A1
(43) Pub. Date: Oct. 20, 2011

(54) METHOD OF DETERMINING CHRONIC FATIGUE SYNDROME

(75) Inventors: YASUHIRO OTOMO, KOBE-SHI (JP); MASAKI KOBAYASHI, KOBE-SHI (JP); HIROHIKO KURATSUNE, OSAKA-SHI (JP); YASUYOSHI WATANABE, OSAKA-SHI (JP)

(73) Assignees: SYSMEX CORPORATION, KOBE-SHI (JP); OSAKA CITY UNIVERSITY GRADUATE SCHOOL OF MEDICINE, OSAKA (JP); OSAKA CITY UNIVERSITY, OSAKA-SHI (JP)

(21) Appl. No.: 12/904,529

(22) Filed: Oct. 14, 2010

(30) Foreign Application Priority Data
Apr. 14, 2010 (JP) 2010-93225

(51) Int. Cl. G06F 19/00

(52) U.S. Cl. 702/19

(57) ABSTRACT

The present invention provides a method of determining whether or not a subject is affected with chronic fatigue syndrome (CFS) comprising: measuring, in a biological sample from the subject, an expression level of a transcript of at least one gene respectively from at least two gene groups selected from six specific gene groups; calculating a value representing a deviation of the measured expression level based on an expression level of a transcript of the corresponding gene in a population of healthy subjects; obtaining an average of the value(s) representing a deviation; and determining whether or not the subject is affected with CFS by using the average.

### CROSS-REFERENCE TO RELATED APPLICATION

This application is related to Japanese patent application No. 2010-93225 filed on Apr. 14, 2010 whose priority is claimed under 35 USC §119, the disclosure of which is incorporated herein by reference in its entirety.

### BACKGROUND OF THE INVENTION

1. Field of the Invention

The present invention relates to a method of determining whether or not a subject is affected with chronic fatigue syndrome (CFS). More specifically, the present invention relates to a method which can determine whether or not a subject is affected with CFS based on a measurement of an expression level of a given gene transcript in a biological sample from a subject.

2. Description of the Related Art

In modern societies, many people chronically feel fatigue. According to the surveillance in 1999 by Ministry of Health, Labour and Welfare of Japan, approximately one-third of Japanese feel chronic fatigue, and economical loss due to the fatigue is estimated about 1.2 trillion yen, suggesting that the fatigue may be a big social concern.

Chronic fatigue syndrome (CFS) is a disease characterized by irreversible intensive fatigue with unknown cause for more than 6 months. It is estimated that there are about 0.3 million and about 3 million patients of CFS in Japan and whole world, respectively, and that there are about 30 million patients-to-be.

At the moment, CFS can only be diagnosed by determination of disability in life based on reports from patients themselves together with by exclusion of possible other diseases accompanied by fatigue after detailed examinations; thus there is no objective determination method for this disease.

WO 98/15646 discloses a diagnosis method of CFS by detecting a blood protein RNase L.

Japanese Unexamined Patent Publication No. 2005-13147 discloses a method of determining a risk of developing CFS based on polymorphism of serotonin transporter gene in the genome of a subject.

Japanese Unexamined Patent Publication No. 2007-228878 discloses a method of diagnosing CFS based on expression levels of genes which have differential expressions in CFS patients.

US Patent Publication No. 2009/0010908 discloses numerous biomarkers (genes) which can be used in the diagnosis of CFS.

Gow et al. (John W Gow et al, “A gene signature for post-infectious chronic fatigue syndrome”, BMC Medical Genomics 2009, 2:38) also identified genes whose expression levels are specific in CFS patients.

### SUMMARY OF THE INVENTION

However, it was difficult to precisely and stably diagnose CFS with prior techniques.

Thus, the object of the present invention is to provide a method which allows precise and stable determination as to whether a subject is affected with CFS.

The present inventors have carried out extensive studies in order to solve the above problem and found that the patients suffering from CFS can be clearly and stably distinguished from healthy subjects by measuring an expression level of a transcript of at least one gene belonging to certain categories (gene groups) in a biological sample from a tested subject, calculating a value representing a deviation of the measured expression level based on an expression level of a transcript of the corresponding gene in a biological sample from a healthy subject, averaging the calculated value in the category, and using the averaged values calculated from at least two categories to determine CFS.

Thus, the present invention provides a method of determining whether or not a subject is affected with chronic fatigue syndrome (CFS) comprising the steps of:

measuring, in a biological sample from the subject, an expression level of a transcript of at least one gene respectively from at least two gene groups selected from energy production-related gene group, virus infection-related gene group, cell death-related gene group, antioxidation-related gene group, immune function-related gene group and iron regulation-related gene group,

calculating a value representing a deviation of the measured expression level based on an expression level of a transcript of the corresponding gene in a population of healthy subjects,

obtaining an average by, (i) when one value representing a deviation is obtained for one gene from the gene group selected, taking the value representing a deviation for the gene as the average, or (ii) when two or more values representing a deviation are obtained for two or more genes from the gene group selected, calculating the average from the values representing a deviation for the two or more genes, and

determining whether or not the subject is affected with CFS by using the obtained average.

Further, the present invention provides a computer program product for enabling a computer to determine whether or not a subject is affected with chronic fatigue syndrome (CFS) comprising a computer readable medium, and software instructions, on the computer-readable medium, for enabling the computer to perform predetermined operations comprising:

receiving an expression level of a transcript of at least one gene respectively from at least two gene groups selected from energy production-related gene group, virus infection-related gene group, cell death-related gene group, antioxidation-related gene group, immune function-related gene group and iron regulation-related gene group measured in a biological sample from the subject,

calculating a value representing a deviation of the measured expression level based on an expression level of a transcript of the corresponding gene in a population of healthy subjects, and obtaining an average by, (i) when one value representing a deviation is obtained for one gene from the gene group selected, taking the value representing a deviation for the gene as the average, or (ii) when two or more values representing a deviation are obtained for two or more genes from the gene group selected, calculating the average from the values representing a deviation for the two or more genes,

determining whether or not the subject is affected with CFS by using the average, and

outputting the result obtained by the determining.

According to the present method, the determination of CFS can be easily carried out from biological samples of subjects, as well as the objective diagnosing tool can be provided. The present method can provide more precise indexes to support the determination of CFS compared to the previous methods.

### BRIEF DESCRIPTION OF THE DRAWINGS

FIG. 1 is a schematic representative showing an apparatus for determining chronic fatigue syndrome for which the present computer program product may be used.

FIG. 2 is a flowchart illustration of specific actions which may be carried out by the present computer program product.

FIG. 3 shows distributions of averages obtained from expression levels of transcripts of genes from energy production-related gene group, virus infection-related gene group, cell death-related gene group, antioxidation-related gene group, immune function-related gene group and iron regulation-related gene group for healthy subjects and CFS patients.

FIG. 4 shows results of determination using averages obtained from expression levels of transcripts of genes from (A) energy production-related gene group and virus infection-related gene group, (B) energy production-related gene group and antioxidation-related gene group, (C) virus infection-related gene group and immune function-related gene group, (D) energy production-related gene group, antioxidation-related gene group and iron regulation-related gene group, (E) energy production-related gene group, cell death-related gene group and immune function-related gene group, (F) antioxidation-related gene group, iron regulation-related gene group and immune function-related gene group, and (G) energy production-related gene group, virus infection-related gene group, cell death-related gene group, antioxidation-related gene group, immune function-related gene group and iron regulation-related gene group for healthy subjects and CFS patients.

FIG. 5 shows results of determination using averages obtained from expression levels of transcripts of genes from energy production-related gene group, virus infection-related gene group, cell death-related gene group, antioxidation-related gene group, immune function-related gene group and iron regulation-related gene group for healthy subjects and CFS patients.

### EXPLANATION OF NUMERALS

1 Measuring apparatus of gene transcript expression level

2 Computer

3 Cable

### DETAILED DESCRIPTION OF THE PREFERRED EMBODIMENTS

According to the present method, an expression level of a transcript of at least one gene respectively from at least two gene groups is measured in a biological sample from a subject, at least two gene groups being selected from energy production-related gene group, virus infection-related gene group, cell death-related gene group, antioxidation-related gene group, immune function-related gene group and iron regulation-related gene group.

The biological sample is not specifically limited so long as it is obtained from living body and from which a transcript of a gene can be extracted. It may be blood (including whole blood, plasma and serum), saliva, urine, body hair and the like.

As used herein, “a transcript of a gene” and “a gene transcript” refer to a product obtained by transcription of the gene and includes ribonucleic acid (RNA), specifically messenger RNA (mRNA).

As used herein, “expression level of a transcript of a gene” refers to an existing amount of a transcript of a gene in the biological sample or an amount which reflects such existing amount. According to the present method, an amount of a transcript of a gene (mRNA) or an amount of complementary deoxyribonucleic acid (cDNA) or complementary RNA (cRNA) may be measured. Generally, the amount of mRNA in biological samples is minute, and therefore the amount of cDNA or cRNA which is obtained from mRNA by reverse transcription or in vitro transcription (IVT) is preferably measured.

Gene transcripts can be extracted from a biological sample using well-known RNA extraction methods. For example, RNA extracts may be obtained by centrifuging the biological sample to precipitate cells containing RNA, physically or enzymatically disrupting the cells and removing cell debris. The extraction of RNA may also be carried out using commercially available RNA extraction kits.

The thus obtained gene transcript extract may be subjected to a treatment for removing contaminants which are derived from the biological sample and are preferably to be excluded at the time of measurement of expression level of the transcript of the gene, such as globin mRNA if the biological sample is blood.

For the thus obtained gene transcript extract, an expression level of a transcript of at least one gene respectively from at least two gene groups selected from energy production-related gene group, virus infection-related gene group, cell death-related gene group, antioxidation-related gene group, immune function-related gene group and iron regulation-related gene group is measured.

The expression level of a gene transcript may be measured according to well-known methods. The measurement is preferably carried out by quantitative PCR or nucleic acid chip techniques because they allow expression analyses of numerous gene transcripts.

When the expression level of a gene transcript is measured with nucleic acid technology, the gene transcript extract or cDNA or cRNA generated from the gene transcript is brought into contact with nucleic probes of 20- to 25-mer long fixed on a substrate and changes in index of hybridization such as fluorescence, color, electric current and the like is determined to measure an expression level of the gene transcript of interest.

At least one nucleic probe may be used for one gene transcript, and more than one nucleic probe may be used according to the length of the gene transcript. The sequence of the probe may be appropriately selected by a person skilled in the art according to the sequence of the gene transcript to be measured.

The measurement of the expression level of a gene transcript using nucleic acid chip technology may be carried out on GeneChip® system provided by Affymetrix, Inc.

When nucleic acid chip technology is used, the gene transcript or its cDNA or cRNA is preferably fragmented in order to promote the hybridization with probes. The fragmentation may be carried out by well-known methods including heating in the presence of metal ions and fragmentation with nucleases such as ribonucleases or deoxyribonucleases.

The amount of the gene transcript or its cDNA or cRNA to be brought into contact with probes on nucleic acid chips may generally be 5 to 20 μg. The condition for the contact is generally at 45° C. for 16 hours or the like.

The transcript or its cDNA or cRNA which has hybridized with a probe can be detected for the formation of hybridization and for the amount of the hybridized transcript based on the changes in a fluorescent substance, dye or electric current passing through the nucleic acid chip.

When the hybridization is detected based on a fluorescent substance or dye, the gene transcript or its cDNA or cRNA is preferably labeled with a labeling substance in order to detect the fluorescent substance or dye. Such labeling substances may include those conventionally used in the art. Generally, in order to label cDNA or cRNA with biotin, biotinylated nucleotide or biotinylated ribonucleotide is mixed as a nucleotide or ribonucleotide substrate at the synthesis of cDNA or cRNA. When cDNA or cRNA is biotinylated, a binding partner for biotin, avidin or streptavidin, can bind to biotin on nucleic acid chips. If avidin or streptavidin is bound to an appropriate fluorescent substance, hybridization can be detected. The fluorescent substance may include fluorescein isothiocyanate (FITC), green fluorescence protein (GFP), luciferin, phycoerythrin and the like. It is usually convenient to use commercially available phycoerythrin-streptavidin conjugates.

Alternatively, a labeled anti-avidin or -streptavidin antibody may be brought into contact with avidin or streptavidin to detect a fluorescent substance or dye of the labeled antibody.

The above six gene groups comply with classifications of categories (GO Terms) defined by Gene Ontology (GO) project. GO Terms can be found in http://www.geneontology.org/index.shtml.

According to the present method, the expression level of a transcript of at least one gene respectively from at least two gene groups among the above six gene groups is measured.

### (A) Energy Production-Related Gene Group

The energy production-related gene group is a category of genes relating to adenosine triphosphate (ATP), which is an energy source in living body. The energy production-related gene group according to the present method preferably comprises (A-1) ATP synthase-related genes, (A-2) mitochondrial ribosomal protein-related genes, (A-3) NADH dehydrogenase-related genes and (A-4) mitochondrial DNA synthesis-related genes.

(A-1) ATP synthase-related genes are the genes which are classified into GO Term of “Mitochondrial proton-transporting ATP synthase complex” (GO: 0005753).

(A-2) Mitochondrial ribosomal protein-related genes are the genes encoding proteins which constitute mitochondrial ribosome or which are present in mitochondria.

(A-3) NADH dehydrogenase-related genes are the genes which are classified into GO Term of “NADH dehydrogenase (ubiquinone) activity” (GO Term: 0008753).

(A-4) Mitochondrial DNA synthesis-related genes are the genes which are classified into GO Term of “Mitochondrial DNA replication” (GO: 0006264).

### (B) Virus Infection-Related Gene Group

The virus infection-related gene group preferably comprises genes encoding interferon-inducible proteins (i.e., interferon-related genes). These genes are classified into the virus infection-related gene group because interferon is produced upon virus infection.

### (C) Cell Death-Related Gene Group

The cell death-related gene group preferably comprises genes related to caspase and sphingomyelin which are known to be related to cell death. Specifically, the cell death-related gene group preferably comprises caspase-related genes and sphingomyelin synthase-related genes.

Caspase-related genes are the genes encoding caspase.

Sphingomyelin synthase-related genes are the genes of enzymes related to the synthesis of sphingomyelin.

### (D) Antioxidation-Related Gene Group

The antioxidation-related gene group preferably comprises glutathione S-transferase related genes because glutathione is a known antioxidant.

Glutathione S-transferase related genes are the genes which are classified into GO Term of “Glutathione transferase activity” (GO: 0004364).

### (E) Immune Function-Related Gene Group

The immune function-related gene group is a group of genes related to immune system, and preferably comprises T-cell receptor-related genes and NK cell receptor-related genes.

T-cell receptor-related genes are the genes encoding T-cell receptors α, β, γ and the like.

NK cell receptor-related genes are the genes encoding NK cell receptors.

### (F) Iron Regulation-Related Gene Group

The iron regulation-related gene group preferably comprises iron-responsive element binding protein-related genes.

Iron-responsive element binding protein-related genes are the genes which are classified into GO Term of “Iron-responsive element binding” (GO: 0030350).

Examples of the genes belonging to each gene group are shown in Table 1.

TABLE 1

| | | GO | | |
|---|---|---|---|---|
| Category | Constituent | term | Gene name | Gene symbol |
| Energy | mitochondrial | GO: 0005753 | ATP synthase 6; ATPase subunit 6 /// OK/SW-cl.16 | ATP6 /// LOC440552 |
| production | proton- | | ATP synthase, H+ transporting, mitochondrial F1 complex, | ATP5D |
| | transporting | | delta subunit | |
| | ATP synthase | | ATPase inhibitory factor 1 | ATPIF1 |
| | complex | | ATP synthase, H+ transporting, mitochondrial F0 complex, | ATP5G1 |
| | | | subunit C1 (subunit 9) | |
| | | | cytochrome c oxidase III /// OK/SW-cl.16 | COX3 /// LOC440552 |
| | | | ATP synthase, H+ transporting, mitochondrial F0 complex, | ATP5G2 |
| | | | subunit C2 (subunit 9) | |
| | | | ATP synthase, H+ transporting, mitochondrial F0 complex, | ATP5G3 |
| | | | subunit C3 (subunit 9) | |
| | | | ATP synthase, H+ transporting, mitochondrial F1 complex, O | ATP5O |
| | | | subunit | |
| | | | ATP synthase, H+ transporting, mitochondrial F1 complex, | ATP5B |
| | | | beta polypeptide | |
| | | | ATP synthase, H+ transporting, mitochondrial F1 complex, | ATP5C1 |
| | | | gamma polypeptide 1 | |
| | | | ATP synthase, H+ transporting, mitochondrial F0 complex, | ATP5J |
| | | | subunit F6 | |
| | | | ATP synthase, H+ transporting, mitochondrial F0 complex, | ATP5I |
| | | | subunit E | |
| | | | ATP synthase, H+ transporting, mitochondrial F0 complex, | ATP5J2 |
| | | | subunit F2 | |
| | | | ATP synthase, H+ transporting, mitochondrial F0 complex, | ATP5F1 |
| | | | subunit B1 | |
| | | | ATP synthase, H+ transporting, mitochondrial F1 complex, | ATP5A1 |
| | | | alpha subunit 1, cardiac muscle | |
| | | | ATP synthase, H+ transporting, mitochondrial F0 complex, | ATP5H |
| | | | subunit d | |
| | | | ATP synthase, H+ transporting, mitochondrial F0 complex, | ATP5L |
| | | | subunit G | |
| | | | ATP synthase, H+ transporting, mitochondrial F1 complex, | ATP5E |
| | | | epsilon subunit | |
| | | | similar to hCG1640299 | LOC100133315 |
| | mitochondrial | | mitochondrial ribosomal protein 63 | MRP63 |
| | ribosomal | | mitochondrial ribosomal protein L1 | MRPL1 |
| | protein genes | | mitochondrial ribosomal protein L10 | MRPL10 |
| | | | mitochondrial ribosomal protein L11 | MRPL11 |
| | | | mitochondrial ribosomal protein L12 | MRPL12 |
| | | | mitochondrial ribosomal protein L13 | MRPL13 |
| | | | mitochondrial ribosomal protein L14 | MRPL14 |
| | | | mitochondrial ribosomal protein L15 | MRPL15 |
| | | | mitochondrial ribosomal protein L16 | MRPL16 |
| | | | mitochondrial ribosomal protein L17 | MRPL17 |
| | | | mitochondrial ribosomal protein L18 | MRPL18 |
| | | | mitochondrial ribosomal protein L19 | MRPL19 |
| | | | mitochondrial ribosomal protein L2 | MRPL2 |
| | | | mitochondrial ribosomal protein L20 | MRPL20 |
| | | | mitochondrial ribosomal protein L21 | MRPL21 |
| | | | mitochondrial ribosomal protein L22 | MRPL22 |
| | | | mitochondrial ribosomal protein L23 | MRPL23 |
| | | | mitochondrial ribosomal protein L24 | MRPL24 |
| | | | mitochondrial ribosomal protein L27 | MRPL27 |
| | | | mitochondrial ribosomal protein L28 | MRPL28 |
| | | | mitochondrial ribosomal protein L3 | MRPL3 |
| | | | mitochondrial ribosomal protein L30 | MRPL30 |
| | | | mitochondrial ribosomal protein L32 | MRPL32 |
| | | | mitochondrial ribosomal protein L33 | MRPL33 |
| | | | mitochondrial ribosomal protein L34 | MRPL34 |
| | | | mitochondrial ribosomal protein L35 | MRPL35 |
| | | | mitochondrial ribosomal protein L36 | MRPL36 |
| | | | mitochondrial ribosomal protein L37 | MRPL37 |
| | | | mitochondrial ribosomal protein L38 | MRPL38 |
| | | | mitochondrial ribosomal protein L39 | MRPL39 |
| | | | mitochondrial ribosomal protein L4 | MRPL4 |
| | | | mitochondrial ribosomal protein L40 | MRPL40 |
| | | | mitochondrial ribosomal protein L41 | MRPL41 |
| | | | mitochondrial ribosomal protein L42 | MRPL42 |
| | | | mitochondrial ribosomal protein L43 | MRPL43 |
| | | | mitochondrial ribosomal protein L44 | MRPL44 |
| | | | mitochondrial ribosomal protein L45 | MRPL45 |
| | | | mitochondrial ribosomal protein L46 | MRPL46 |
| | | | mitochondrial ribosomal protein L47 | MRPL47 |
| | | | mitochondrial ribosomal protein L48 | MRPL48 |
| | | | mitochondrial ribosomal protein L49 | MRPL49 |
| | | | mitochondrial ribosomal protein L50 | MRPL50 |
| | | | mitochondrial ribosomal protein L51 | MRPL51 |
| | | | mitochondrial ribosomal protein L51 /// serine | MRPL51 /// SPTLC1 |
| | | | palmitoyltransferase, long chain base subunit 1 | |
| | | | mitochondrial ribosomal protein L52 | MRPL52 |
| | | | mitochondrial ribosomal protein L53 | MRPL53 |
| | | | mitochondrial ribosomal protein L54 | MRPL54 |
| | | | mitochondrial ribosomal protein L55 | MRPL55 |
| | | | mitochondrial ribosomal protein L9 | MRPL9 |
| | | | mitochondrial ribosomal protein S10 | MRPS10 |
| | | | mitochondrial ribosomal protein S11 | MRPS11 |
| | | | mitochondrial ribosomal protein S12 | MRPS12 |
| | | | mitochondrial ribosomal protein S14 | MRPS14 |
| | | | mitochondrial ribosomal protein S15 | MRPS15 |
| | | | mitochondrial ribosomal protein S16 | MRPS16 |
| | | | mitochondrial ribosomal protein S17 | MRPS17 |
| | | | mitochondrial ribosomal protein S18A | MRPS18A |
| | | | mitochondrial ribosomal protein S18B | MRPS18B |
| | | | mitochondrial ribosomal protein S18C | MRPS18C |
| | | | mitochondrial ribosomal protein S2 | MRPS2 |
| | | | mitochondrial ribosomal protein S21 | MRPS21 |
| | | | mitochondrial ribosomal protein S22 | MRPS22 |
| | | | mitochondrial ribosomal protein S23 | MRPS23 |
| | | | mitochondrial ribosomal protein S24 | MRPS24 |
| | | | mitochondrial ribosomal protein S25 | MRPS25 |
| | | | mitochondrial ribosomal protein S26 | MRPS26 |
| | | | mitochondrial ribosomal protein S27 | MRPS27 |
| | | | mitochondrial ribosomal protein S28 | MRPS28 |
| | | | mitochondrial ribosomal protein S30 | MRPS30 |
| | | | mitochondrial ribosomal protein S31 | MRPS31 |
| | | | mitochondrial ribosomal protein S33 | MRPS33 |
| | | | mitochondrial ribosomal protein S34 | MRPS34 |
| | | | mitochondrial ribosomal protein S35 | MRPS35 |
| | | | mitochondrial ribosomal protein S36 | MRPS36 |
| | | | mitochondrial ribosomal protein S5 | MRPS5 |
| | | | mitochondrial ribosomal protein S6 | MRPS6 |
| | | | mitochondrial ribosomal protein S7 | MRPS7 |
| | | | mitochondrial ribosomal protein S9 | MRPS9 |
| | NADH | GO: 0008753 | NADH dehydrogenase (ubiquinone) Fe—S protein 7, 20 kDa | NDUFS7 |
| | dehydrogenase | | (NADH-coenzyme Q reductase) | |
| | (ubiquinone) | | NADH dehydrogenase (ubiquinone) 1 beta subcomplex, 7, | NDUFB7 |
| | activity | | 18 kDa | |
| | | | NADH dehydrogenase (ubiquinone) Fe—S protein 1, 75 kDa | NDUFS1 |
| | | | (NADH-coenzyme Q reductase) | |
| | | | NADH dehydrogenase (ubiquinone) 1 alpha subcomplex, 9, | NDUFA9 |
| | | | 39 kDa | |
| | | | NADH dehydrogenase (ubiquinone) 1 beta subcomplex, 3, | NDUFB3 |
| | | | 12 kDa | |
| | | | NADH dehydrogenase (ubiquinone) Fe—S protein 2, 49 kDa | NDUFS2 |
| | | | (NADH-coenzyme Q reductase) | |
| | | | NADH dehydrogenase (ubiquinone) 1 alpha subcomplex, 13 | NDUFA13 |
| | | | NADH dehydrogenase (ubiquinone) Fe—S protein 8, 23 kDa | NDUFS8 |
| | | | (NADH-coenzyme Q reductase) | |
| | | | NADH dehydrogenase (ubiquinone) Fe—S protein 3, 30 kDa | NDUFS3 |
| | | | (NADH-coenzyme Q reductase) | |
| | | | NADH dehydrogenase (ubiquinone) flavoprotein 2, 24 kDa | NDUFV2 |
| | | | NADH dehydrogenase (ubiquinone) flavoprotein 1, 51 kDa | NDUFV1 |
| | | | NADH dehydrogenase (ubiquinone) 1 beta subcomplex, 8, | NDUFB8 /// SEC31B |
| | | | 19 kDa /// SEC31 homolog B (S. cerevisiae) | |
| | | | NADH dehydrogenase (ubiquinone) 1 beta subcomplex, 8, | NDUFB8 |
| | | | 19 kDa | |
| | | | NADH dehydrogenase (ubiquinone) 1 beta subcomplex, 1, | NDUFB1 |
| | | | 7 kDa | |
| | | | NADH dehydrogenase (ubiquinone) 1 alpha subcomplex, 12 | NDUFA12 |
| | | | NADH dehydrogenase (ubiquinone) 1 beta subcomplex, 11, | NDUFB11 |
| | | | 17.3 kDa | |
| | | | NADH dehydrogenase (ubiquinone) 1 alpha subcomplex, 11, | NDUFA11 |
| | | | 14.7 kDa | |
| | mitochondrial | GO: 0006264 | ribonucleotide reductase M2 B (TP53 inducible) | RRM2B |
| | DNA | | polymerase (DNA directed), gamma | POLG |
| | replication | | | |
| Virus | Interferon | | interferon, gamma-inducible protein 16 | IFI16 |
| infection | inducible | | interferon, alpha-inducible protein 27 | IFI27 |
| | protein | | interferon, alpha-inducible protein 27-like 1 | IFI27L1 |
| | genes | | interferon, alpha-inducible protein 27-like 2 | IFI27L2 |
| | | | interferon, gamma-inducible protein 30 | IFI30 |
| | | | interferon-induced protein 35 | IFI35 |
| | | | interferon-induced protein 44 | IFI44 |
| | | | interferon-induced protein 44-like | IFI44L |
| | | | interferon, alpha-inducible protein 6 | IFI6 |
| | | | interferon induced with helicase C domain 1 | IFIH1 |
| | | | interferon-induced protein with tetratricopeptide repeats 1 | IFIT1 |
| | | | interferon-induced protein with tetratricopeptide repeats 2 | IFIT2 |
| | | | interferon-induced protein with tetratricopeptide repeats 3 | IFIT3 |
| | | | interferon-induced protein with tetratricopeptide repeats 5 | IFIT5 |
| | | | interferon induced transmembrane protein 1 (9-27) | IFITM1 |
| | | | interferon induced transmembrane protein 2 (1-8D) | IFITM2 |
| | | | interferon induced transmembrane protein 3 (1-8U) | IFITM3 |
| Cell | Caspase | | caspase 1, apoptosis-related cysteine peptidase (interleukin 1, | CASP1 |
| death | genes | | beta, convertase) | |
| | | | caspase 10, apoptosis-related cysteine peptidase | CASP10 |
| | | | caspase 12 (gene/pseudogene) | CASP12 |
| | | | caspase 14, apoptosis-related cysteine peptidase | CASP14 |
| | | | caspase 2, apoptosis-related cysteine peptidase | CASP2 |
| | | | caspase 3, apoptosis-related cysteine peptidase | CASP3 |
| | | | caspase 4, apoptosis-related cysteine peptidase | CASP4 |
| | | | caspase 5, apoptosis-related cysteine peptidase | CASP5 |
| | | | caspase 6, apoptosis-related cysteine peptidase | CASP6 |
| | | | caspase 7, apoptosis-related cysteine peptidase | CASP7 |
| | | | caspase 8 associated protein 2 | CASP8AP2 |
| | | | caspase 8, apoptosis-related cysteine peptidase | CASP8 |
| | | | caspase 9, apoptosis-related cysteine peptidase | CASP9 |
| | | | sterile alpha motif domain containing 8 | SAMD8 |
| | Sphingomyelin | GO: 33188 | sphingomyelin synthase 2 | SGMS2 |
| | | | sphingomyelin synthase 1 | SGMS1 |
| | | | sphingosine-1-phosphate lyase 1 | SGPL1 |
| | | | sphingosine-1-phosphate phosphatase 1 | SGPP1 |
| | | | sphingosine-1-phosphate phosphotase 2 | SGPP2 |
| Anti- | glutathione | GO: 0004364 | glutathione S-transferase theta pseudogene 1 | GSTTP1 |
| oxidation | transferase | | GSTT1 mRNA | GSTT1 |
| | activity | | glutathione S-transferase alpha 3 | GSTA3 |
| | | | leukotriene C4 synthase | LTC4S |
| | | | glutathione S-transferase alpha 4 | GSTA4 |
| | | | glutathione S-transferase mu 5 | GSTM5 |
| | | | glutathione S-transferase mu 3 (brain) | GSTM3 |
| | | | glutathione S-transferase theta 2 | GSTT2 |
| | | | Glutathione S-transferase 2 (GST) | GSTA1 |
| | | | glutathione S-transferase mu 4 | GSTM4 |
| | | | glutathione transferase zeta 1 | GSTZ1 |
| | | | glutathione S-transferase mu 1 | GSTM1 |
| | | | glutathione S-transferase mu 2 (muscle) | GSTM2 |
| | | | glutathione S-transferase omega 2 | GSTO2 |
| | | | microsomal glutathione S-transferase 2 | MGST2 |
| | | | glutathione S-transferase kappa 1 | GSTK1 |
| | | | microsomal glutathione S-transferase 3 | MGST3 |
| | | | microsomal glutathione S-transferase 1 | MGST1 |
| | | | glutathione S-transferase omega 1 | GSTO1 |
| | | | glutathione S-transferase pi 1 | GSTP1 |
| | | | glutathione S-transferase, C-terminal domain containing | GSTCD |
| Immune | T cell | | T cell receptor alpha constant | TRAC |
| function | receptor | | T cell receptor alpha locus /// T cell receptor alpha constant | TRA@ /// TRAC |
| | genes | | T cell receptor alpha locus /// T cell receptor alpha constant /// | TRA@ /// TRAC /// TRAJ17 /// |
| | | | T cell receptor alpha joining 17 /// T cell receptor alpha | TRAV20 |
| | | | variable 20 | |
| | | | T cell receptor alpha locus /// T cell receptor alpha constant /// | TRA@ /// TRAC /// TRAJ17 /// |
| | | | T cell receptor alpha joining 17 /// T cell receptor alpha | TRAV20 /// TRD@ |
| | | | variable 20 /// T cell receptor delta locus | |
| | | | T cell receptor alpha locus /// T cell receptor alpha joining 17 | TRA@ /// TRAJ17 /// TRAV20 /// |
| | | | /// T cell receptor alpha variable 20 /// T cell receptor delta | TRD@ |
| | | | locus | |
| | | | T cell receptor alpha locus /// T cell receptor delta locus | TRA@ /// TRD@ |
| | | | T cell receptor alpha variable 8-3 | TRAV8-3 |
| | | | T cell receptor associated transmembrane adaptor 1 | TRAT1 |
| | | | T cell receptor beta constant 1 | TRBC1 |
| | | | T cell receptor beta constant 1 /// T cell receptor beta constant 2 | TRBC1 /// TRBC2 |
| | | | T cell receptor beta constant 1 /// T cell receptor beta constant | TRBC1 /// TRBC2 /// TRBV7-4 /// |
| | | | 2 /// T cell receptor beta variable 7-4 (gene/pseudogene) /// T | TRBV7-6 /// TRBV7-7 /// TRBV7-8 |
| | | | cell receptor beta variable 7-6 /// T cell receptor beta variable | |
| | | | 7-7 /// T cell receptor beta variable 7-8 | |
| | | | T cell receptor beta variable 10-2 | TRBV10-2 |
| | | | T cell receptor beta variable 24-1 | TRBV24-1 |
| | | | T cell receptor beta variable 25-1 | TRBV25-1 |
| | | | T cell receptor beta variable 7-3 | TRBV7-3 |
| | | | T cell receptor beta variable 7-8 | TRBV7-8 |
| | | | T cell receptor delta locus | TRD@ |
| | | | T cell receptor gamma variable 5 | TRGV5 |
| | NK | | killer cell immunoglobulin-like receptor, three domains, long | KIR3DL1 |
| | receptor | | cytoplasmic tail, 1 | |
| | | | killer cell immunoglobulin-like receptor, three domains, long | KIR3DL1 /// KIR3DS1 |
| | | | cytoplasmic tail, 1 /// killer cell immunoglobulin-like receptor, | |
| | | | three domains, short cytoplasmic tail, 1 | |
| | | | killer cell immunoglobulin-like receptor, three domains, long | KIR3DL2 /// LOC727787 |
| | | | cytoplasmic tail, 2 /// similar to killer cell immunoglobulin-like | |
| | | | receptor 3DL2 precursor (MHC class I NK cell receptor) | |
| | | | (Natural killer-associated transcript 4) (NKAT-4) (p70 natural | |
| | | | killer cell receptor clone CL-5) (CD158k antigen) | |
| | | | killer cell immunoglobulin-like receptor, three domains, long | KIR3DL3 |
| | | | cytoplasmic tail, 3 | |
| | | | killer cell immunoglobulin-like receptor, three domains, X1 | KIR3DX1 |
| | | | killer cell immunoglobulin-like receptor, two domains, long | KIR2DL1 /// KIR2DL2 /// KIR2DL3 /// |
| | | | cytoplasmic tail, 1 /// killer cell immunoglobulin-like receptor, | KIR2DL5A /// KIR2DL5B /// KIR2DS1 |
| | | | two domains, long cytoplasmic tail, 2 /// killer cell | /// KIR2DS2 /// KIR2DS3 /// KIR2DS4 |
| | | | immunoglobulin-like receptor, two domains, long cytoplasmic | /// KIR2DS5 /// KIR3DL1 /// KIR3DL2 |
| | | | tail, 3 /// killer cell immunoglobulin-like receptor, two domains, | /// KIR3DL3 /// KIR3DP1 /// KIR3DP1 |
| | | | long cytoplasmic tail, 5A /// killer cell immunoglobulin-like | /// LOC652001 /// LOC652779 /// |
| | | | receptor, two domains, long cytoplasmic tail, 5B /// killer cell | LOC727787 |
| | | | immunoglobulin-like receptor, two domains, short cytoplasmic | |
| | | | tail, 1 /// killer cell immunoglobulin-like receptor, two domains, | |
| | | | short cytoplasmic tail, 2 /// killer cell immunoglobulin-like | |
| | | | receptor, two domains, short cytoplasmic tail, 3 /// killer cell | |
| | | | immunoglobulin-like receptor, two domains, short cytoplasmic | |
| | | | tail, 4 /// killer cell immunoglobulin-like receptor, two domains, | |
| | | | short cytoplasmic tail, 5 /// killer cell immunoglobulin-like | |
| | | | receptor, three domains, long cytoplasmic tail, 1 /// killer cell | |
| | | | immunoglobulin-like receptor, three domains, long cytoplasmic | |
| | | | tail, 2 /// killer cell immunoglobulin-like receptor, three | |
| | | | domains, long cytoplasmic tail, 3 /// killer cell | |
| | | | immunoglobulin-like receptor, three domains, pseudogene 1 | |
| | | | /// killer-cell Ig-like receptor /// similar to killer cell | |
| | | | immunoglobulin-like receptor, two domains, long cytoplasmic | |
| | | | tail, 5B /// similar to Killer cell immunoglobulin-like receptor | |
| | | | 2DS3 precursor (MHC class I NK cell receptor) (Natural killer | |
| | | | associated transcript 7) (NKAT-7) /// similar to killer cell | |
| | | | immunoglobulin-like receptor 3DL2 precursor (MHC class I NK | |
| | | | cell receptor) (Natural killer-associated transcript 4) (NKAT-4) | |
| | | | (p70 natural killer cell receptor clone CL-5) (CD158k antigen) | |
| | | | killer cell immunoglobulin-like receptor, two domains, long | KIR2DL2 |
| | | | cytoplasmic tail, 2 | |
| | | | killer cell immunoglobulin-like receptor, two domains, long | KIR2DL3 |
| | | | cytoplasmic tail, 3 | |
| | | | killer cell immunoglobulin-like receptor, two domains, long | KIR2DL4 |
| | | | cytoplasmic tail, 4 | |
| | | | killer cell immunoglobulin-like receptor, two domains, long | KIR2DL5A |
| | | | cytoplasmic tail, 5A | |
| | | | killer cell immunoglobulin-like receptor, two domains, short | KIR2DS1 |
| | | | cytoplasmic tail, 1 | |
| | | | killer cell immunoglobulin-like receptor, two domains, short | KIR2DS1 /// KIR2DS2 /// KIR2DS4 |
| | | | cytoplasmic tail, 1 /// killer cell immunoglobulin-like receptor, | |
| | | | two domains, short cytoplasmic tail, 2 /// killer cell | |
| | | | immunoglobulin-like receptor, two domains, short cytoplasmic | |
| | | | tail, 4 | |
| | | | killer cell immunoglobulin-like receptor, two domains, short | KIR2DS3 |
| | | | cytoplasmic tail, 3 | |
| | | | killer cell immunoglobulin-like receptor, two domains, short | KIR2DS4 |
| | | | cytoplasmic tail, 4 | |
| | | | killer cell immunoglobulin-like receptor, two domains, short | KIR2DS5 |
| | | | cytoplasmic tail, 5 | |
| | | | killer cell lectin-like receptor subfamily A, member 1 | KLRA1 |
| | | | killer cell lectin-like receptor subfamily B, member 1 | KLRB1 |
| | | | killer cell lectin-like receptor subfamily C, member 1 /// killer | KLRC1 /// KLRC2 |
| | | | cell lectin-like receptor subfamily C, member 2 | |
| | | | killer cell lectin-like receptor subfamily C, member 3 | KLRC3 |
| | | | killer cell lectin-like receptor subfamily C, member 4 | KLRC4 |
| | | | killer cell lectin-like receptor subfamily C, member 4 /// killer | KLRC4 /// KLRK1 |
| | | | cell lectin-like receptor subfamily K, member 1 | |
| | | | killer cell lectin-like receptor subfamily D, member 1 | KLRD1 |
| | | | killer cell lectin-like receptor subfamily F, member 1 | KLRF1 |
| | | | killer cell lectin-like receptor subfamily G, member 1 | KLRG1 |
| | | | killer cell lectin-like receptor subfamily G, member 2 | KLRG2 |
| | | | killer cell lectin-like receptor subfamily K, member 1 | KLRK1 |
| Iron | iron-responsive | GO: 0030350 | aconitase 1, soluble | ACO1 |
| regulatio | element | | iron-responsive element binding protein 2 | IREB2 |
| | binding | | | |

Among the above genes listed in Table 1, according to the present method, it is preferable to measure an expression level of a transcript of at least one gene listed in Table 2 for at least two gene groups.

In Table 2, “Probe Set ID” is an ID number for identifying a probe set for gene recognition in GeneChip® from Affymetrix, Inc. The sequences of probes can be obtained from, for example, http://www.affymetrix.com/analysis/index.affx.

The sequences of these genes are already known and can be obtained from databases such as Entrez, Ensemble and Unigene, with their ID numbers shown in Table 2.

TABLE 2

| Gene group | Gene title | Gene symbol | Probe set ID | Entrez Gene | Ensembl | UniGene ID |
|---|---|---|---|---|---|---|
| Energy production | ATP synthase, H+ transporting, | ATP5B | 201322_at | 506 | ENSG00000110955 | Hs.406510 |
| | mitochondrial F1 complex, beta | | | | | |
| | polypeptide | | | | | |
| | ATP synthase, H+ transporting, | ATP5G3 | 207508_at | 518 | ENSG00000154518 | Hs.429 |
| | mitochondrial F0 complex, subunit C3 | | | | | |
| | (subunit 9) | | | | | |
| | ATP synthase, H+ transporting, | ATP5G2 | 208764_s_at | 517 | ENSG00000135390 | Hs.524464 |
| | mitochondrial F0 complex, subunit C2 | | | | | |
| | (subunit 9) | | | | | |
| | ATP synthase, H+ transporting, | ATP5G1 | 208972_s_at | 516 | ENSG00000159199 | Hs.80986 |
| | mitochondrial F0 complex, subunit C1 | | | | | |
| | (subunit 9) | | | | | |
| | ATP synthase, H+ transporting, | ATP5D | 213041_s_at | 513 | ENSG00000099624 | Hs.418668 |
| | mitochondrial F1 complex, delta subunit | | | | | |
| | mitochondrial ribosomal protein S14 | MRPS14 | 203800_s_at | 63931 | ENSG00000120333 | Hs.702192 |
| | mitochondrial ribosomal protein L12 | MRPL12 | 203931_s_at | 6182 | ENSG00000183093 | Hs.109059 |
| | mitochondrial ribosomal protein S12 | MRPS12 | 204331_s_at | 6183 | ENSG00000128626 | Hs.411125 |
| | mitochondrial ribosomal protein L23 | MRPL23 | 213897_s_at | 6150 | ENSG00000214026 | Hs.3254 |
| | mitochondrial ribosomal protein S7 | MRPS7 | 217932_at | 51081 | ENSG00000125445 | Hs.71787 |
| | mitochondrial ribosomal protein S35 | MRPS35 | 217942_at | 60488 | ENSG00000061794 | Hs.311072 |
| | mitochondrial ribosomal protein L16 | MRPL16 | 217980_s_at | 54948 | ENSG00000166902 | Hs.530734 |
| | mitochondrial ribosomal protein S16 | MRPS16 | 218046_s_at | 51021 | ENSG00000182180 | Hs.180312 |
| | mitochondrial ribosomal protein S17 | MRPS17 | 218982_s_at | 51373 | ENSG00000154999 | Hs.44298 |
| | mitochondrial ribosomal protein L11 | MRPL11 | 219162_s_at | 65003 | ENSG00000174547 | Hs.418450 |
| | mitochondrial ribosomal protein L46 | MRPL46 | 219244_s_at | 26589 | ENSG00000173867 | Hs.534261 |
| | mitochondrial ribosomal protein L34 | MRPL34 | 221692_s_at | 64981 | ENSG00000130312 | Hs.515242 |
| | mitochondrial ribosomal protein L17 | MRPL17 | 222216_s_at | 63875 | ENSG00000158042 | Hs.696199 |
| | mitochondrial ribosomal protein S24 | MRPS24 | 224948_at | 64951 | ENSG00000062582 | Hs.284286 |
| | mitochondrial ribosomal protein L38 | MRPL38 | 225103_at | 64978 | ENSG00000204316 | Hs.442609 |
| | mitochondrial ribosomal protein L14 | MRPL14 | 225201_s_at | 64928 | ENSG00000180992 | Hs.311190 |
| | mitochondrial ribosomal protein L21 | MRPL21 | 225315_at | 219927 | ENSG00000197345 | Hs.503047 |
| | mitochondrial ribosomal protein L53 | MRPL53 | 225523_at | 116540 | ENSG00000204822 | Hs.534527 |
| | mitochondrial ribosomal protein L52 | MRPL52 | 226241_s_at | 122704 | ENSG00000172590 | Hs.355935 |
| | NADH dehydrogenase (ubiquinone) 1, | NDUFAB1 | 202077_at | 4706 | ENSG00000004779 | Hs.189716 |
| | alpha/beta subcomplex, 1, 8 kDa | | | | | |
| | NADH dehydrogenase (ubiquinone) 1, | NDUFC1 | 203478_at | 4717 | ENSG00000109390 | Hs.84549 |
| | subcomplex unknown, 1, 6 kDa | | | | | |
| | NADH dehydrogenase (ubiquinone) 1 | NDUFA2 | 209224_s_at | 4695 | ENSG00000131495 | Hs.534333 |
| | alpha subcomplex, 2, 8 kDa | | | | | |
| | NADH dehydrogenase (ubiquinone) 1, | NDUFC2 | 218101_s_at | 4718 | ENSG00000151366 | Hs.407860 |
| | subcomplex unknown, 2, 14.5 kDa | | | | | |
| | NADH dehydrogenase (ubiquinone) 1 | LOC727762 /// | 218226_s_at | 4710 /// | ENSG00000065518 | Hs.594079 |
| | beta subcomplex, 4, 15 kDa /// similar to | NDUFB4 | | 727762 | /// | |
| | NADH dehydrogenase (ubiquinone) 1 | | | | ENSG00000215727 | |
| | beta subcomplex, 4, 15 kDa | | | | | |
| | NADH dehydrogenase (ubiquinone) 1 | NDUFB11 | 218320_s_at | 54539 | ENSG00000147123 | Hs.521969 |
| | beta subcomplex, 11, 17.3 kDa | | | | | |
| | NADH dehydrogenase (ubiquinone) 1 | NDUFA13 | 220864_s_at | 51079 | ENSG00000130288 | Hs.534453 |
| | alpha subcomplex, 13 | | | | | |
| | NADH dehydrogenase (ubiquinone) 1 | NDUFB9 | 222992_s_at | 4715 | ENSG00000147684 | Hs.15977 |
| | beta subcomplex, 9, 22 kDa | | | | | |
| | NADH dehydrogenase (ubiquinone) 1 | NDUFB10 | 223112_s_at | 4716 | ENSG00000140990 | Hs.513266 |
| | beta subcomplex, 10, 22 kDa | | | | | |
| | NADH dehydrogenase (ubiquinone) 1 | NDUFA12 | 223244_s_at | 55967 | ENSG00000184752 | Hs.506374 |
| | alpha subcomplex, 12 | | | | | |
| | NADH dehydrogenase (ubiquinone) 1 | NDUFA11 | 228690_s_at | 126328 | ENSG00000213496 | Hs.406062 |
| | alpha subcomplex, 11, 14.7 kDa | | | | | |
| | polymerase (DNA directed), gamma | POLG | 203366_at | 5428 | ENSG00000140521 | Hs.706868 |
| Cell death | caspase 1, apoptosis-realted cysteine | CASP1 /// COP1 | 1552703_s_at | 114769 /// 834 | ENSG00000137752 | Hs.348365 |
| | peptidase (interleukin 1, beta, | | | | /// | |
| | convertase) /// caspase-1 | | | | ENSG00000204397 | |
| | dominant-negative inhibitor pseudo-ICE | | | | | |
| | caspase recruitment domain family, | CARD8 | 1554479_a_at | 22900 | ENSG00000105483 | Hs.446146 |
| | member 8 | | | | | |
| | caspase 3, apoptosis-related cysteine | CASP3 | 202763_at | 836 | ENSG00000164305 | Hs.141125 |
| | peptidase | | | | | |
| | caspase 9, apoptosis-related cysteine | CASP9 | 203984_s_at | 842 | ENSG00000132906 | Hs.329502 |
| | peptidase | | | | | |
| | caspase 5, apoptosis-related cysteine | CASP5 | 207500_at | 838 | ENSG00000137757 | Hs.213327 |
| | peptidase | | | | | |
| | caspase 4, apoptosis-related cysteine | CASP4 | 209310_s_at | 837 | ENSG00000196954 | Hs.138378 |
| | peptidase | | | | | |
| | caspase 1, apoptosis-related cysteine | CASP1 | 209970_x_at | 834 | ENSG00000137752 | Hs.2490 |
| | peptidase (interleukin 1, beta, | | | | | |
| | cconvertase) | | | | | |
| | caspase 6, apoptodsis-related cysteine | CASP6 | 211464_x_at | 839 | | Hs.654616 |
| | peptidase | | | | | |
| | caspase 8, apoptosis-related cysteine | CASP8 | 213373_s_at | 841 | ENSG00000064012 | Hs.599762 |
| | peptidase | | | | | |
| | caspase recruitment domain family, | CARD6 | 224414_s_at | 84674 | ENSG00000132357 | Hs.200242 |
| | member 6 | | | | | |
| | sphingomyelin synthase 1 | SGMS1 | 212989_at | 259230 | ENSG00000198964 | Hs.654698 |
| | sphingosine-1-phosphate phosphatase | SGPP1 | 223391_at | 81537 | ENSG00000126821 | Hs.24678 |
| | 1 | | | | | |
| | sphingomyelin synthase 2 | SGMS2 | 227038_at | 166929 | | Hs.595423 |
| Virus infection | interferon, gamma-inducible protein 16 | IFI16 | 206332_s_at | 3428 | ENSG00000163565 | Hs.380250 |
| | interferon induced with helicase C | IFIH1 | 219209_at | 64135 | ENSG00000115267 | Hs.163173 |
| | domain 1 | | | | | |
| Antioxidation | glutathione S-transferase pi | GSTP1 | 200824_at | 2950 | ENSG00000084207 | Hs.523836 |
| | glutathione S-transferase omega 1 | GSTO1 | 201470_at | 9446 | ENSG00000148834 | Hs.190028 |
| | glutathione S-transferase M3 (brain) | GSTM3 | 202554_s_at | 2947 | ENSG00000134202 | Hs.2006 |
| | glutathione S-transferase M2 (muscle) | GSTM2 | 204418_x_at | 2946 | ENSG00000134184 | Hs.279837 |
| | | | | | /// | |
| | | | | | ENSG00000213366 | |
| | glutathione S-transferase M1 | GSTM1 | 204550_x_at | 2944 | ENSG00000134184 | Hs.301961 |
| | glutathione S-transferase M5 | GSTM5 | 205752_s_at | 2949 | ENSG00000134201 | Hs.75652 |
| | glutathione S-transferase M4 | GSTM4 | 210912_x_at | 2948 | ENSG00000168765 | Hs.348387 |
| | glutathione S-transferase kappa 1 | GSTK1 | 217751_at | 373156 | ENSG00000197448 | Hs.390667 |
| | glutathione S-transferase, C-terminal | GSTCD | 220063_at | 79807 | | Hs.161429 |
| | domain containing | | | | | |
| | glutathione S-transferase A4 | GSTA4 | 235405_at | 2941 | ENSG00000170899 | Hs.485557 |
| Immune function | T cell receptor alpha locus /// T cell | TRA@ /// TRAC | 209671_x_at | 28755 /// 6955 | | Hs.74647 |
| | receptor alpha constant | | | | | |
| | T cell receptor alpha locus /// T cell | TRA@ /// TRAC /// | 210972_x_at | 28663 /// 28738 /// 28755 /// 6955 | | Hs.74647 |
| | receptor delta variable 2 /// T cell | TRAJ17 /// | | | | |
| | receptor alpha variable 20 /// T cell | TRAV20 /// TRDV2 | | | | |
| | receptor alpha joining 17 /// T cell | | | | | |
| | receptor alpha constant | | | | | |
| | T cell receptor alpha locus | TRA@ | 211902_x_at | 6955 | | Hs.74647 |
| | T cell receptor alpha locus /// YME1-like | TRA@ /// TRAC /// | 215524_x_at | 28663 /// | ENSG00000211816 | Hs.74647 |
| | 1 (S. cerevisiae) /// T cell receptor delta | TRAJ17 /// | | 28738 /// | /// | |
| | variable 2 /// T cell receptor alpha | TRAV20 /// TRDV2 | | 28755 /// 6955 | ENSG00000211835 | |
| | variable 20 /// T cell receptor alpha | /// YME1L1 | | /// 6964 | /// | |
| | joining 17 /// T cell receptor alpha | | | | ENSG00000211889 | |
| | constant | | | | | |
| | T cell receptor gamma constant 2 /// T | TARP /// TRGC2 | 216920_s_at | 445347 /// | | Hs. 534032 |
| | cell receptor gamma varibale 9 /// TCR | /// TRGV9 | | 6967 | | |
| | gamma alternate reading frame protein | | | | | |
| | T cell receptor alpha locus /// T cell | TRA@ /// TRD@ | 217143_s_at | 6955 /// 6964 | | Hs. 74647 |
| | receptor delta locus | | | | | |
| | T cell receptor, V beta 6.9, J beta 2.1, C | TRBC1 | 234883_x_at | 28595 | ENSG00000211714 | |
| | beta 2 /// T cell receptor beta constant 1 | | | | | |
| | /// T-cell receptor active beta-chain | | | | | |
| | VD1.1J2.5 mRNA /// T-cell receptor | | | | | |
| | rearranged alpha chain mRNA | | | | | |
| | V-NDN-J-C region (cell line B6.6) | | | | | |
| | killer cell immunoglobulin-like receptor, | KIR3DL2 | 207314_x_at | 3812 /// | ENSG00000213016 | Hs.645532 |
| | three domains, long cytoplasmic tail, 2 | | | 727787 | | |
| | killer cell immunoglobulin-like receptor, | KIR2DS3 | 208122_x_at | 3808 | | |
| | two domains, short cytoplasmic tail, 3 | | | | | |
| | killer cell immunoglobulin-like receptor, | KIR2DL3 /// | 208179_x_at | 3804 | ENSG00000221920 | |
| | two domains, long cytoplasmic tail, 3 /// | KIR2DS5 | | | | |
| | killer cell immunoglobulin-like receptor, | | | | | |
| | two domains, short cystoplasmic tail, 5 | | | | | |
| | killer cell immunoglobulin-like receptor, | KIR2DS1 | 208198_x_at | 3806 | ENSG00000215767 | |
| | two domains, short cytoplasmic tail, 1 | | | | | |
| | killer cell immunoglobulin-like receptor, | KIR2DL1 /// | 210890_x_at | 3802 | ENSG00000125498 | Hs.654605 |
| | two domains, long cytoplasmic tail, 1 /// | KIR2DL2 | | | | |
| | killer cell immunoglobulin-like receptor, | | | | | |
| | two domains, long cytoplasmic tail, 2 | | | | | |
| | killer cell immunoglobulin-like receptor, | KIR3DS1 | 211389_x_at | 3811 /// 3813 | ENSG00000215758 | Hs.683173 |
| | three domains, short cytoplasmic tail, 1 | | | | | |
| | killer cell immunoglobulin-like receptor, | KIR2DL5A | 211410_x_at | 57292 | ENSG00000188484 | Hz.676464 |
| | two domains, long cytoplasmic tail 5A | | | | | |
| | killer cell immunoglobulin-like receptor, | KIR2DS2 /// | 211532_x_at | 100132285 /// | ENSG00000215757 | Hs.654608 |
| | two domains, short cytoplasmic tail, 2 /// | KIR2DS3 /// | | 3806 /// 3809 | /// | |
| | killer cell immunoglobulin-like receptor, | KIR2DS4 | | | ENSG00000215767 | |
| | two domains, short cytoplasmic tail, 3 /// | | | | /// | |
| | killer cell immunoglobulin-like receptor, | | | | ENSG00000221957 | |
| | two domains, short cytoplasmic tail, 4 | | | | | |
| | killer cell immunoglobulin-like receptor, | KIR3DL1 | 211687_x_at | 3811 | ENSG00000167633 | Hs.645228 |
| | three domains, long cytoplasmic tail, 1 | | | | | |
| | killer cell immunoglobulin-like receptor, | KIR2DS4 | 216552_x_at | 3809 | ENSG00000221957 | Hs.654608 |
| | two domains, short cytoplasmic tail, 4 | | | | | |
| | killer cell immunoglobulin-like receptor, | KIR3DL3 | 216676_x_at | 115653 | ENSG00000189096 | Hs.645224 |
| | three domains, long cytoplasmic tail, 3 | | | | /// | |
| | | | | | ENSG00000221906 | |
| Iron regulation | iron-responsive element binding protein | IREB2 | 225892_at | 3658 | ENSG00000136381 | Hs.436031 |
| | 2 | | | | | |

The gene transcript expression level obtained in this step is not specifically limited so long as it relatively represents an existing amount of the gene transcript in the biological sample. When nucleic acid chip technology is used for the measurement, the expression level may be signal obtained from nucleic acid chips based on fluorescence intensity, color intensity, amount of current and the like.

Such signal can be measured with a measuring apparatus for nucleic acid chips.

Next, a value representing a deviation of the measured expression level based on an expression level of a transcript of the corresponding gene in a population of healthy subjects is calculated.

As used herein, “a transcript of the corresponding gene” means a transcript of the same gene for which the expression level from the subject has been measured.

The expression level of a transcript of the corresponding gene in a population of healthy subjects can be obtained by measuring the expression level of the target gene transcript in biological samples obtained from healthy subjects according to the similar procedures used for a biological sample from the subject.

As used herein, “healthy subject” means a person who is confirmed as healthy by doctor's questions and general blood test. As used herein, “a patient of chronic fatigue syndrome” and “a CFS patient” mean a person who is diagnosed as CFS by a medical specialist.

“A population of healthy subjects” may be a population having statistically sufficient size such as a group comprising 30 or more, preferably 40 or more people.

The value representing a deviation can be calculated according to the following equation:

A value representing a deviation={(Expression level of a transcript of a gene in a subject)−(An average of expression levels of a transcript of the corresponding gene in a population of healthy subjects)}/(Standard deviation of expression levels of the transcript of the corresponding gene in the population of healthy subjects)

The above value representing a deviation is a value also known as Z score which represents the distance of the expression level of the gene transcript of the subject from the expression levels of the transcript in the healthy subject population.

Next, an average is obtained by, (i) when one value representing a deviation is obtained for one gene from the gene group selected, taking the value representing a deviation for the gene as the average, or (ii) when two or more values representing a deviation are obtained for two or more genes from the gene group selected, calculating the average from the values representing a deviation for the two or more genes.

Thus, as used herein, when a value representing a deviation for only one gene is obtained in the gene group for which the average is to be obtained, “an average” means the value representing the deviation for the one gene, and when values representing a deviation for two or more genes are obtained, it means a value obtained by averaging out these values representing a deviation.

The above average is obtained for at least two gene groups selected from energy production-related gene group, virus infection-related gene group, cell death-related gene group, antioxidation-related gene group, immune function-related gene group and iron regulation-related gene group. Preferably, the average is obtained for at least three gene groups, more preferably for at least four gene groups, still more preferably for at least five gene groups and most preferably for six gene groups.

The thus obtained averages are used to determine whether or not the subject is affected with CFS.

This determination can be carried out by feeding the above averages from the subject to a determination equation obtained from an average preliminary obtained by corresponding steps described above using biological samples from healthy subjects and an average preliminary obtained by corresponding steps described above using biological samples from CFS patients. The determination equation can be obtained by a known software Support Vector Machine (SVM).

The averages calculated from a biological sample from the subject may be fed to SVM to which the average from healthy subjects and the average from CFS patients have been fed to obtain the determination equation, thereby determining whether or not the subject is affected with CFS.

The present method preferably has the sensitivity, i.e., a probability of the method to determine a CFS patient as “positive”, of 80% or more, more preferably 85% or more and still more preferably 90% or more. The present method preferably has the specificity, i.e., a probability of the method to determine a healthy subject as “negative”, of 60% or more, more preferably 70% or more, still more preferably 80% or more and particularly preferably 90% or more.

Because the present method has such high sensitivity and specificity, it can provide precise and stable diagnoses.

The present invention also provides a computer program product for enabling a computer to carry out the present method. Thus, the computer program product of the present invention comprises a computer readable medium, and software instructions, on the computer-readable medium, for enabling the computer to perform predetermined operations comprising:

receiving an expression level of a transcript of at least one gene respectively from at least two gene groups selected from energy production-related gene group, virus infection-related gene group, cell death-related gene group, antioxidation-related gene group, immune function-related gene group and iron regulation-related gene group measured in a biological sample from the subject,

calculating a value representing a deviation of the measured expression level based on an expression level of a transcript of the corresponding gene in a population of healthy subjects, and obtaining an average by, (i) when one value representing a deviation is obtained for one gene from the gene group selected, taking the value representing a deviation for the gene as the average, or (ii) when two or more values representing a deviation are obtained for two or more genes from the gene group selected, calculating the average from the values representing a deviation for the two or more genes,

determining whether or not the subject is affected with CFS by using the average, and

outputting the result obtained by the determining.

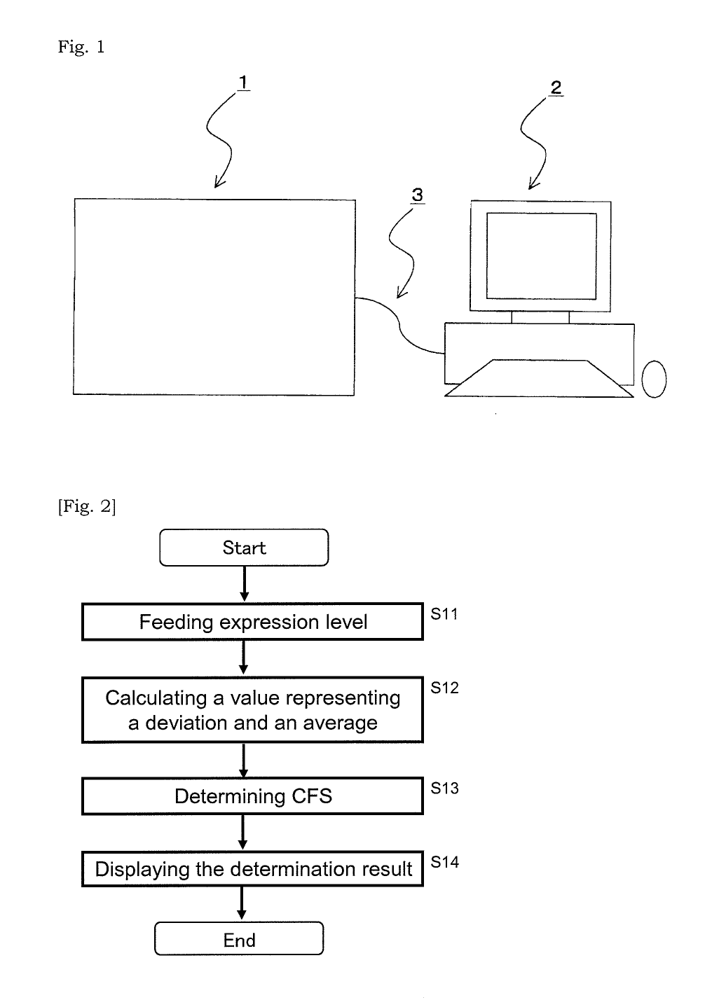

FIG. 1 shows an example of an apparatus for determining CFS for which the present computer program product may be used. The apparatus is constituted by a measuring apparatus of gene transcript expression level 1, a computer 2 and a cable 3 connecting them. Expression level data such as signal based on fluorescence intensity, amount of current and the like which is measured in the measuring apparatus 1 can be sent to the computer 2 via the cable 3. The measuring apparatus 1 may not be connected to the computer 2. In this case, expression level data is fed to the computer to operate the computer program product.

In the computer 2, the obtained expression level is used to calculate the value representing a deviation, the value is converted to the average for each of at least two gene groups and the averages are used for the determination as to whether the subject is affected with CFS.

The present computer program product may be in cooperation with the computer 2 comprising a central processing unit, a memory part, a reader for compact disc, Floppy® disc etc., an input part such as a keyboard and an output part such as a display to carry out the present method.

FIG. 2 shows more specific actions which may be carried out in the computer 2 with the present computer program product.

First, the expression level of the gene transcript measured in the measuring apparatus of gene transcript expression level is fed to CPU of the computer 2 (step S11).

CPU then processes the fed expression level to obtain a value representing a deviation based on the expression level of a transcript of the corresponding gene in a population of healthy subjects and an average of the obtained value representing a deviation for each of at least two gene groups (step S12).

CPU further determines whether or not the subject is affected with CFS using the obtained average (step S13). This determination can be carried out by feeding the above averages to a determination equation obtained from an average preliminary obtained by using biological samples from healthy subjects and an average preliminary obtained by using biological samples from CFS patients.

Namely, it is preferable that the average preliminary obtained from healthy subjects and the average preliminary obtained from CFS patients have already been stored in the hard disk of the computer 2. More preferably, Support Vector Machine has already been installed in the hard disc of the computer 2 and the above averages have been stored in the SVM.

CPU feeds an average from the subject to the determination equation obtained from the preliminary stored averages, and displays on a displaying apparatus such as a display of a computer the determination results as to whether or not the subject is affected with CFS (step S14).

### EXAMPLES

The present invention is further illustrated by means of the following Examples which do not limit the present invention.

### Example 1

### Establishment of the Present Method

### (1) Blood Samples Used

Blood samples obtained from the following subjects were used as biological samples in the present Example.

| | |
|---|---|
| Blood from healthy subjects 1 (average age: 38.3 years) | 63 samples |
| Blood from CFS patients (average age: 36.7 years) | 100 samples |

The subjects were determined to be healthy or CFS by using SVM.

### (2) Extraction of RNA From Blood

From 5 ml of blood taken with a syringe, total RNA was extracted with PAXgene Blood RNA system (PreanalytiX GmbH) according to the following procedures. All reagents and columns used are contained in PAXgene Blood RNA system.

Blood taken with a syringe (2.5 ml) was transferred to a blood collecting tube for RNA extraction, PAXgene Blood RNA Tube (PreanalytiX GmbH), mixed up and down for about 10 times and left to stand at room temperature for 2 hours. The blood was immediately used or stored at −80° C. The blood collecting tube for RNA extraction containing blood was centrifuged at 4000×g for 10 minutes and the supernatant was removed. The pellet was suspended in 4 ml of Ribonuclease free water and centrifuged at 4000×g for 10 minutes to remove the supernatant. The pellet was suspended in 350 μl of BRI buffer.

The content was transferred to a 1.5-mL tube and 300 μl of BR2 buffer and 40 μl of Protein Kinase solution were added. After voltexing for 5 seconds, the tube was incubated in a thermoshaker at 55° C. and 1000 rpm for 10 minutes. A PSC column was loaded with the content, centrifuged at 14000 rpm for 3 minutes and the obtained filtrate was transferred to a 1.5-mL tube. The tube was added with 350 μl of ethanol, voltexed and spun. A PRC column was loaded with 700 μl of the supernatant and centrifuged at 12000 rpm for 1 minute, and the filtrate was discarded. The remained supernatant was also passed through the PRC column in a similar manner. The PRC column was loaded with 350 μl of BR3 buffer and centrifuged at 12000 rpm for 1 minute, and the filtrate was discarded. The PRC column was loaded with 70 μl of RDD+10 μl of DNase and left to stand at room temperature for 15 minutes, and the filtrate was discarded. The PRC column was loaded with 350 μl of BR3 buffer and centrifuged at 12000 rpm for 1 minute, and the filtrate was discarded. The PRC column was then loaded with 500 μl of BR4 buffer and centrifuged at 12000 rpm for 1 minute, and the filtrate was discarded. The same procedure (centrifugation for 3 minutes) was repeated one more time. The empty PRC column was centrifuged at 12000 rpm for 1 minute. The column was placed with a new 1.5-mL tube, loaded with 4 μl of BR5 buffer and centrifuged at 12000 rpm for 1 minute. The same procedure was repeated one more time. The obtained filtrate was incubated at 65° C. for 5 minutes and placed on ice.

### (3) Removal of Globin RNA From Total RNA Derived From Whole Blood

The total RNA obtained as the above procedures was subjected to the removal of globin RNA using GLOBINclear-Human kit (Ambion, Inc.) according to the following procedures.

To the solution of total RNA were added 0.1 volume of 5M NH₄OAc, 5 μg of glycogen and 2.5 volumes of ethanol and the mixture was left to stand at −80° C. for 30 to 60 minutes. The mixture was centrifuged at 14000 rpm and 4° C. for 30 minutes and the supernatant was removed. The pellet was added with 1 mL of cold 80% ethanol, mixed, and centrifuged at 14000 rpm and 4° C. for 10 minutes to remove the supernatant. The same procedure was repeated one more time. The pellet was dried for 15 minutes and dissolved in 20 μl of nuclease-free water.

The thus concentrated RNA solution (1 to 10 μg, maximum 14 μl) was placed with a tube provided with GLOBINclear-Human kit, and 1 μl of Capture Oligo Mix provided with the kit and nuclease-free water up to 15 μl were added. The provided 2× Hybridization Buffer (15 μl) was added, voltexed, spun and incubated at 50° C. for 15 minutes.

Streptavidin Magnetic Beads (30 μl) were added which were prepared from Streptavidin Magnetic Beads, Streptavidin Bead Buffer and 2× Hybridization Buffer according to the instruction of the kit, all of which were provided with the kit, and the mixture was voltexed, spun, snapped to mix and incubated at 50° C. for 30 minutes. Thereafter, the mixture was voltexed, spun, and left to stand on a magnetic separation stand for 3 to 5 minutes. The supernatant was collected.

The supernatant was added with 100 μl of RNA Binding Buffer and 20 μl of voltexed Beads Suspension Mix and voltexed for 10 seconds. The mixture was spun and left to stand on a magnetic separation stand for 3 to 5 minutes. After the removal of the supernatant, 200 μl of RNA Wash Solution was added. The mixture was voltexed for 10 seconds, spun and left to stand on a magnetic separation stand for 3 to 5 minutes. After the removal of the supernatant, the pellet was dried, added with 20 μl of Elution Buffer heated to 58° C., voltexed for 10 seconds and incubated at 58° C. for 5 minutes. The mixture was further voltexed for 10 seconds, left to stand on a magnetic separation stand for 3 to 5 minutes and the supernatant was collected to recover RNA from which globin RNA was removed.

### (4) Preparation of Targets for GeneChip®

The thus obtained total RNA was used to prepare biotinylated target cRNA to be used for GeneChip® with GeneChip One-Cycle Target Labeling and Control Reagents (Affymetrix, Inc.) according to the following procedures, in order to measure expression levels of gene transcripts.

(4-1) Synthesis of 1^{st} Strand of cDNA

The following reagents were incubated in a PCR tube at 70° C. for 10 minutes and then 4° C. for 2 minutes or more.

| | |
|---|---|
| Total RNA (1 μg) | 3 μl |
| RNase-free water | 5 μl |
| 20-fold diluted Poly-A RNA Control | 2 μl |
| T7-Oligo (dT) Primer 50 μM | 2 μl |
| Total | 12 μl |

The following reagents were further added and the tube was tapped.

| | |
|---|---|
| 5x First Strand Reaction Mix | 4 μl |
| DTT 0.1M | 2 μl |
| dNTP 10 mM | 1 μl |
| Total | 7 μl |

The tube was incubated at 42° C. for 2 minutes, added with 1 μl of Super Script II and incubated at 42° C. for 1 hour and then at 4° C. for 2 minutes or more to synthesize the 1^{st} strand of cDNA.

(4-2) Synthesis of 2^{nd} Strand of cDNA

The following reagents were added to the synthesized 1st strand of cDNA and the tube was tapped.

| | |
|---|---|
| RNase-free water | 91 μl |
| 5x 2^{nd} Strand Reaction Mix | 30 μl |
| dNTP 10 mM | 3 μl |
| E. coli DNA ligase | 1 μl |
| E. coli DNA polymerase I | 4 μl |
| RNaseH | 1 μl |
| Total | 130 μl |

The mixture was incubated at 16° C. for 2 hours, added with 2 μl of T4 DNA polymerase, incubated at 16° C. for 5 minutes, added with 10 μl of 0.5M EDTA to synthesize the 2^{nd} strand of cDNA.

(4-3) Washing of cDNA

The thus synthesized 2^{nd} strand cDNA was transferred to a 1.5-mL tube, added with 600 μl of cDNA Binding Buffer and voltexed. The mixture (500 μl) was loaded to cDNA Cleanup Spin Column, which was then centrifuged at 10000 rpm for 1 minute, and the filtrate was discarded. The rest of cDNA was loaded to the column, which was then centrifuged in a similar manner. The column was placed with a new 2-mL tube, loaded with 750 μl of cDNA Wash Buffer, centrifuged and the filtrate was discarded. The column was centrifuged at 14000 rpm for 5 minutes. The column was placed with a new 1.5-mL tube, loaded with 14 μl of cDNA Elution Buffer, left to stand for 1 minute, and centrifuged at 14000 rpm for 1 minute to wash cDNA.

### (4-4) IVT Labeling

The obtained cDNA was transformed to biotinylated cRNA by in vitro transcription (IVT) according to the following procedures.

The following reagents were mixed in a PCR tube and incubated at 37° C. for 16 hours to obtain cRNA. The following reagents are attached to One-Cycle Target Labeling and Control Reagents kit.

| | |
|---|---|
| cDNA from step (4-3) | 12 μl |
| RNase-free water | 8 μl |
| 10× IVT Labeling Buffer | 4 μl |
| IVT Labeling NTP Mix | 12 μl |
| IVT Labeling Enzyme Mix | 4 μl |
| Total | 40 μl |

(4-5) Washing of cRNA

The thus obtained cRNA was transferred to a 1.5-mL tube, added with 60 μl of RNase-free water and voltexed. To the tube was added 350 μl of IVT CRNA Binding Buffer, voltexed, added with 250 μl of 100% EtOH and mixed with pipetting. cRNA Cleanup Spin Column was loaded with the content, centrifuged at 1000 rpm for 15 seconds and placed with a new tube. The column was loaded with 500 μl of IVT cRNA Wash Buffer and centrifuged at 10000 rpm for 15 seconds, and the filtrate was discarded. The column was loaded with 500 μl of 80% EtOH and centrifuged at 10000 rpm for 15 seconds, and the filtrate was discarded. The column was centrifuged at 14000 rpm for 5 minutes to dry before the column was placed with a new tube. The column was loaded with 11 μl of RNase-free water, left to stand for 1 minute and centrifuged at 14000 rpm for 1 minute. Further, the column was loaded with 10 μl of RNase-free water, left to stand for 1 minute and centrifuged at 14000 rpm for 1 minute. The thus obtained filtrate was diluted at 200-fold and measured for absorbance to determine the amount of cRNA.

(4-6) Fragmentation of cRNA

The following reagents were mixed in a tube and incubated at 94° C. for 35 minutes to obtain fragmented cRNA before storage at 4° C.

The following reagents are attached to One-Cycle Target Labeling and Control Reagents kit.

| | |
|---|---|
| cRNA from step (4-5) | 10 μl |
| 5× Fragmentation Buffer | 8 μl |
| RNase-free water | 22 μl |
| Total | 40 μl |

### (5) Measurement of Gene Expression Level by GeneChip®

Gene expression level was measured with fragmented and biotinylated cRNA obtained in step (4) by hybridization in GeneChip®. The nucleic acid chip used was Human Genome U133 Plus 2.0 Array. The hybridization conditions were as follows.

### <Hybridization Solution>

| | | |
|---|---|---|
| Fragmented cRNA | 15 or 12.6 or 12.1 | μg |
| Control Oligo B2 | 5 | μl |
| 20x Eukaryotic Hyb control | 15 | μl |
| 2x Hybridization Mix | 150 | μl |
| DMSO | 30 | μl |
| Nuclease-free water | Up to 300 | μl |

### <Hybridization Temperature Conditions>

99° C. for 5 minutes→45° C. for 5 minutes→14000 rpm for 5 minutes

The chip was stained and washed on Fluidic Station 450 (Affymetrix, Inc.) apparatus using GeneChip Hybridization Wash and Stain kit (Affymetrix, Inc.) according to the supplier's instructions, which stains hybridized target cRNA with streptavidin-phycoerythrin conjugate.

The chip was scanned on GeneChip Scanner 3000 (Affymetrix, Inc.).

### (6) Extraction of Expression Data

Scanned image data was transformed to CEL file using DNA microarray analysis software GeneChip Operating Software (GCOS; Affymetrix, Inc.), which was then normalized with ArrayAssist (Stratagene) software, and correlation coefficients between measurement results of samples from subjects were calculated. Normalized algorithm used was MAS5.0.

### (7) Data Analysis

### (7-1) Refinement of Probe Sets

Among the genes corresponding to about 56,000 probe sets analyzed as above, only the maximum signal values were extracted for the genes for which two or more different probe sets were analyzed. Further, the genes having a signal value of 100 or less were excluded. As a result, the genes corresponding to about 17,000 probe sets were selected for the following analyses.

### (7-2) Transformation of Expression Levels to Z Scores

For the transcripts of genes corresponding to about 17,000 probe sets selected as above, all signal values obtained from healthy subjects 1 (63 samples) were used to calculate average and standard deviation. These values were entered to the following equation to obtain the values representing a deviation of each gene (Z scores) for the about 17,000 genes.

Z score={(a signal value of a transcript of a gene)−(an average of signal values of a transcript of the corresponding gene in healthy subjects (63 samples))}/(a standard deviation of signal values of the transcript of the corresponding gene in healthy subjects (63 samples))

### (7-3) Grouping of Genes and Calculation of Averages for Each Group

The above about 17,000 genes were classified into GO Terms according to the classification in Gene Ontology (http://www.geneontology.org/index.shtml). Z scores obtained in (7-2) for the genes in each GO Term were averaged.

In a similar manner, averages in GO Terms were calculated for 100 samples from CFS patients.

### (7-4) Selection of Gene Groups Which are Different Between Healthy Subjects and CFS Patients

The thus obtained averages in GO Terms from healthy subjects and CFS patients were subjected to T-test to obtain P values.

The GO Terms used were divided into several groups based on their functions or intracellular localizations and the groups which contain more GO Terms having P value<1.0E-05 were selected.

Hierarchical cluster analysis was carried out with Z scores of all genes contained in the selected groups, and clusters of genes which synchronously vary were selected.

Scores for clusters which correspond to the averages of Z scores of genes contained in each cluster were subjected to T-test for healthy subjects (63 samples) and CFS patients (100 samples). The clusters having P value<1.0E-05 were selected, which were energy production-related gene group, virus infection-related gene group, cell death-related gene group, antioxidation-related gene group, immune function-related gene group and iron regulation-related gene group. It is believed that these gene groups can be parameters for distinguishing healthy subjects and CFS patients. These gene groups and genes belonging thereto are shown in Table 2.

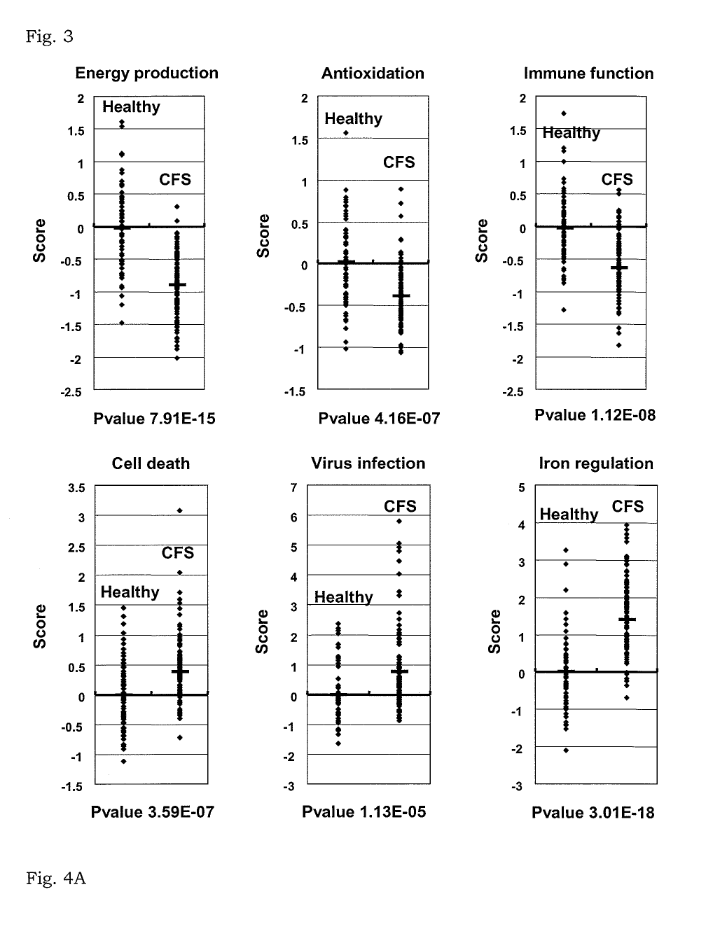

FIG. 3 shows averages of Z scores obtained in (7-3) in the selected gene groups for healthy subjects and CFS patients. These results show that healthy subjects and CFS patients can be distinguished by using the averages for these gene groups.

### Example 2

Among six gene groups identified in Example 1, the averages for healthy subjects 1 (63 samples) and CFS patients (100 samples) in each of the following groups (A) to (G) were fed to Support Vector Machine (SVM; contained in the analysis software ArrayAssist) to obtain determination equations:

(A) energy production-related gene group and virus infection-related gene group;

(B) energy production-related gene group and antioxidation-related gene group;

(C) virus infection-related gene group and immune function-related gene group;

(D) energy production-related gene group, antioxidation-related gene group and iron regulation-related gene group;

(E) energy production-related gene group, cell death-related gene group and immune function-related gene group;

(F) antioxidation-related gene group, iron regulation-related gene group and immune function-related gene group; and

(G) energy production-related gene group, virus infection-related gene group, cell death-related gene group, antioxidation-related gene group, immune function-related gene group and iron regulation-related gene group.

The SVM fed with these averages from 163 samples was used to assess the performance as to whether the samples were determined to be positive (CFS) or negative (healthy).

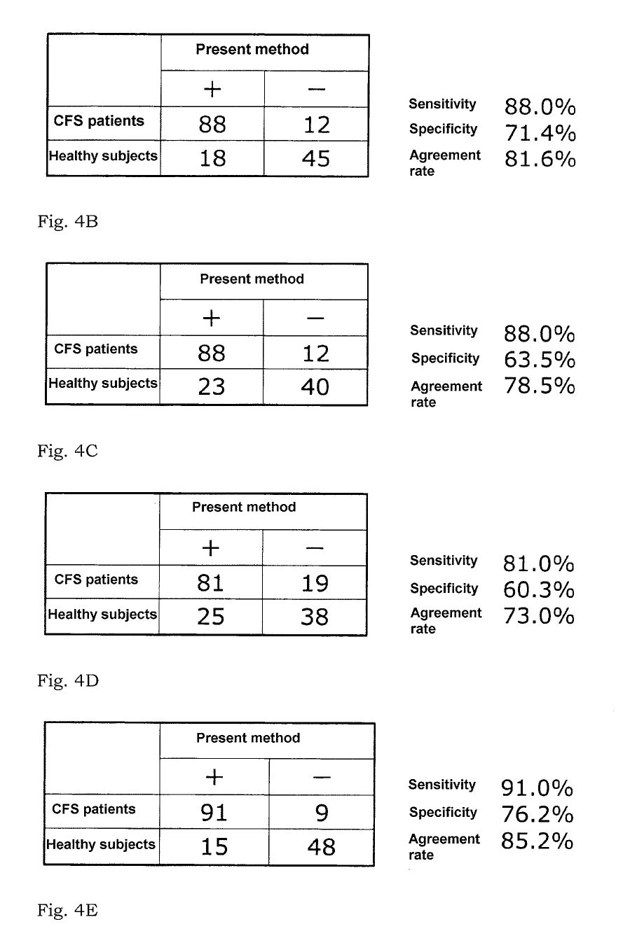

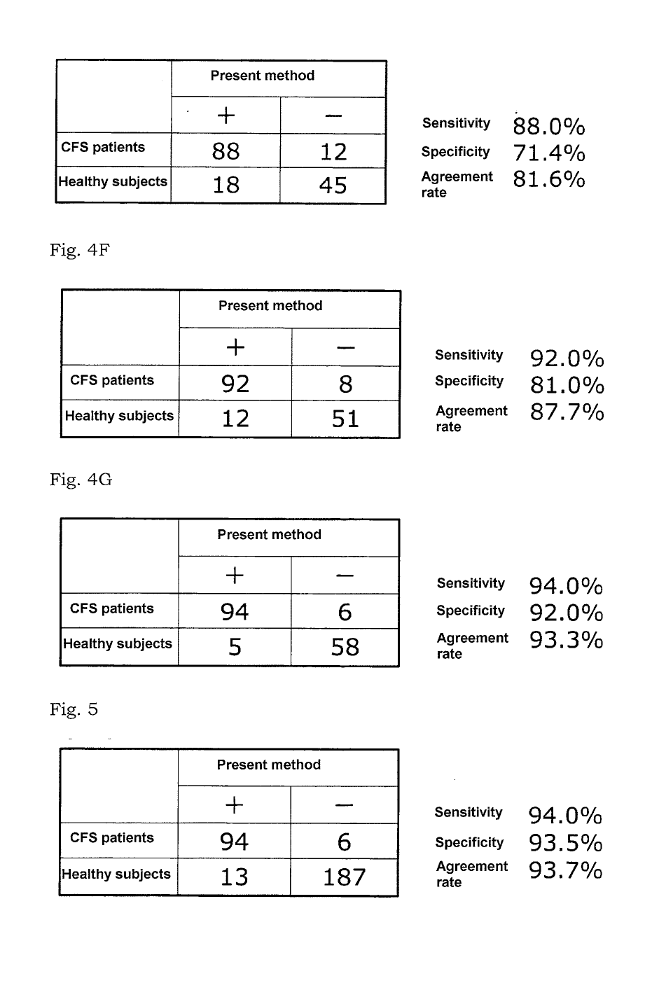

The results are shown in FIGS. 4A to 4G. FIGS. 4A to 4G respectively show the results using SVMs which were fed with the averages in the above two, three or six gene groups.

In FIG. 4, “sensitivity” is the rate that a CFS patient is determined to be “positive” and “specificity” is the rate that a healthy subject is determined to be “negative”. “Agreement rate” is the rate that a CFS patient is determined to be “positive” and a healthy subject is determined to be “negative”.

These results show that the present method can identify CFS patients with sensitivity of 80% or more and specificity of 60% or more.

In addition, it is found that an increase in the number of gene groups to be measured improves accuracy of the determination.

### Example 3

The performance of the determination equation obtained in Example 2 was further assessed with 200 blood samples from healthy subjects 2 (average age: 20.4 years). The results are shown in FIG. 5.

FIG. 5 shows that healthy subjects and CFS patients can be stably distinguished according to the present method.

What is claimed is:

1. A method of determining whether or not a subject is affected with chronic fatigue syndrome (CFS) comprising the steps of:
measuring, in a biological sample from the subject, an expression level of a transcript of at least one gene respectively from at least two gene groups selected from energy production-related gene group, virus infection-related gene group, cell death-related gene group, antioxidation-related gene group, immune function-related gene group and iron regulation-related gene group,
calculating a value representing a deviation of the measured expression level based on an expression level of a transcript of the corresponding gene in a population of healthy subjects,
obtaining an average by, (i) when one value representing a deviation is obtained for one gene from the gene group selected, taking the value representing a deviation for the gene as the average, or (ii) when two or more values representing a deviation are obtained for two or more genes from the gene group selected, calculating the average from the values representing a deviation for the two or more genes, and
determining whether or not the subject is affected with CFS by using the obtained average.

2. The method according to claim 1, wherein the expression level of a transcript of at least one gene respectively from at least three gene groups is measured in the measuring step.

3. The method according to claim 1, wherein:
the energy production-related gene group comprises ATP synthase-related genes, mitochondrial ribosomal protein-related genes,
NADH dehydrogenase-related genes and mitochondrial DNA synthesis-related genes,
the virus infection-related gene group comprises interferon-related genes,
the cell death-related gene group comprises caspase-related genes and sphingomyelin synthase-related genes,
the antioxidation-related gene group comprises glutathione S-transferase related genes,
the immune function-related gene group comprises T-cell receptor-related genes and NK cell receptor-related genes, and
the iron regulation-related gene group comprises iron-responsive element binding protein-related genes.

4. The method according to claim 1, wherein:
the gene in the energy production-related gene group is selected from the group consisting of the genes having Entrez Gene IDs 506, 518, 517, 516, 513, 63931, 6182, 6183, 6150, 51081, 60488, 54948, 51021, 51373, 65003, 26589, 64981, 63875, 64951, 64978, 64928, 219927, 116540, 122704, 4706, 4717, 4695, 4718, 4710 / / / 727762, 54539, 51079, 4715, 4716, 55967, 126328 and 5428;
the gene in the cell death-related gene group is selected from the group consisting of the genes having Entrez Gene IDs 114769 / / / 834, 22900, 836, 842, 838, 837, 834, 839, 841, 84674, 259230, 81537 and 166929;
the gene in the virus infection-related gene group is selected from the group consisting of the genes having Entrez Gene IDs 3428 and 64135;
the gene in the antioxidation-related gene group is selected from the group consisting of the genes having Entrez Gene IDs 2950, 9446, 2947, 2946, 2944, 2949, 2948, 373156, 79807 and 2941,
the gene in the immune function-related gene group is selected from the group consisting of the genes having Entrez Gene IDs 28755 / / / 6955, 28663 / / / 28738 / / / 28755 / / / 6955, 6955, 28663 / / / 28738 / / / 28755 / / / 6955 / / / 6964, 445347 / / / 6967, 6955 / / / 6964, 28595, 3812 / / / 727787, 3808, 3804, 3806, 3802, 3811 / / / 3813, 57292, 100132285 / / / 3806 / / / 3809, 3811, 3809 / / / 115653; and
the gene in the iron regulation-related gene group is the gene having Entrez Gene ID 3658.

5. The method according to claim 1, wherein the biological sample is blood.

6. The method according to claim 1, wherein the determining step is carried out by feeding the average obtained from the subject to a determination equation obtained from an average preliminary obtained by corresponding steps to the steps of measuring, calculating and obtaining using biological samples from healthy subjects and an average preliminary obtained by corresponding steps to the steps of measuring, calculating and obtaining using biological samples from CFS patients.

7. The method according to claim 6, wherein the determination equation is generated with Support Vector Machine.

8. A computer program product for enabling a computer to determine whether or not a subject is affected with chronic fatigue syndrome (CFS) comprising a computer readable medium, and software instructions, on the computer-readable medium, for enabling the computer to perform predetermined operations comprising:
receiving an expression level of a transcript of at least one gene respectively from at least two gene groups selected from energy production-related gene group, virus infection-related gene group, cell death-related gene group, antioxidation-related gene group, immune function-related gene group and iron regulation-related gene group measured in a biological sample from the subject,
calculating a value representing a deviation of the measured expression level based on an expression level of a transcript of the corresponding gene in a population of healthy subjects, and obtaining an average by, (i) when one value representing a deviation is obtained for one gene from the gene group selected, taking the value representing the deviation for the gene as the average, or (ii) when two or more values representing a deviation are obtained for two or more genes from the gene group selected, calculating the average from the values representing a deviation for the two or more genes,
determining whether or not the subject is affected with CFS by using the average, and
outputting the result obtained by the determining.

9. The computer program product according to claim 8, which comprises Support Vector Machine.
